(19) United States
(12) Patent Application Publication
(10) Pub. No.: US 2024/0215538 A1
(43) Pub. Date: Jul. 4, 2024

(54) GROOMING SYSTEMS FOR A HORSE COAT

(71) Applicant: Achieve Equine LLC, Delano, MN (US)

(72) Inventors: James R. Chiapetta, Delano, MN (US); Jan Weber, Maastricht (NL)

(21) Appl. No.: 18/558,117

(22) PCT Filed: May 4, 2022
(86) PCT No.: PCT/US22/27628

§ 371 Date: Oct. 30, 2023

Related U.S. Application Data
(60) Provisional application No. 63/184,037, filed on May 4, 2021.

(51) Int. Cl. A01K 13/00; A46B 5/00; A46B 13/00; A46B 13/02

(52) U.S. Cl. CPC A01K 13/002; A46B 5/005; A46B 5/0083; A46B 13/008; A46B 13/02; A46B 2200/1093

(57) ABSTRACT

Grooming tools and systems for grooming an animal. An illustrative grooming tool may comprise a housing having a top edge, a bottom edge, and a sidewall extending between the top edge and the bottom edge. A first pad and a second pad may each form a portion of a bottom surface of the housing. A plurality of cleaning fibers may extend from each of the first and second pads. A motor configured to drive rotation of the pads may be disposed within the cavity of the housing. The first pad may be configured to rotate in a first direction relative to a center of the bottom surface of the housing and the second pad may be configured to rotate in a second direction opposite the first direction.

### CROSS REFERENCE TO RELATED APPLICATIONS

The present application claims the benefit of and priority to U.S. Prov. Pat. App. No. 63/184,037, filed May 4, 2021, and titled GROOMING SYSTEMS FOR A HORSE COAT, the disclosure of which is incorporated herein by reference.

### TECHNICAL FIELD

The disclosure is directed to generally to animal grooming systems. More particularly, this disclosure is directed towards grooming systems for animals that may be particularly advantageous for livestock and horses.

### BACKGROUND

There are various steps and manual tools involved in the process of grooming animals such as livestock and horses. The first step may be to use a rubber curry comb in small (about the size of the palm) circular motions to loosen excess dirt and mud. The process typically starts at the neck and the groomer works their way down each side of the animal, such as a horse. This process is then continued using a hard and/or stiff brush in short, brisk strokes to remove excess dirt and mud that was loosened with the curry comb. The grooming process may then be continued with a third, and sometimes a fourth, brush with finer and/or softer hairs. This process may take significant time and energy. Novel tools are needed.

### SUMMARY

The disclosure is directed to several alternative designs for a grooming system. In a first example, a grooming tool may comprise a housing having a top edge, a bottom edge, and a sidewall extending between the top edge and the bottom edge. The housing may define a cavity. The grooming tool may further comprise a first pad forming a portion of a bottom surface of the housing, a second pad forming a portion of the bottom surface of the housing, a plurality of cleaning fibers extending from each of the first and second pads, and a motor operably coupled to the first pad and the second pad. The first pad may be configured to rotate in a first direction relative to a center of the bottom surface of the housing and the second pad may be configured to rotate in a second direction opposite the first direction.

Alternatively or additionally to any of the examples above, in another example, the first and second pads may be removably coupled relative to the housing.

Alternatively or additionally to any of the examples above, in another example, at least some of the plurality of cleaning fibers may be configured to rotate independent of the first and/or second pads.

Alternatively or additionally to any of the examples above, in another example, the first pad may have an annular configuration and the second pad may be disposed radially inward of the first pad.

Alternatively or additionally to any of the examples above, in another example, the motor may be disposed within the cavity of the housing.

Alternatively or additionally to any of the examples above, in another example, the motor may be disposed exterior to the cavity of the housing.

Alternatively or additionally to any of the examples above, in another example, the motor may be configured to be clipped to a belt of a user.

Alternatively or additionally to any of the examples above, in another example, the motor may be operably coupled to the first pad and the second pad via a flexible motor shaft.

Alternatively or additionally to any of the examples above, in another example, the grooming tool may further comprise a handle releasably secured to the housing.

Alternatively or additionally to any of the examples above, in another example, the handle may comprise a hinge positioned adjacent to a distal end region thereof, the hinge may be configured to pivot the distal end region of the handle relative to a proximal end region of the handle.

Alternatively or additionally to any of the examples above, in another example, the handle may be configured to expand or contract between a plurality of lengths.

Alternatively or additionally to any of the examples above, in another example, the grooming tool may further comprise a power source disposed within the handle.

Alternatively or additionally to any of the examples above, in another example, the grooming tool may further comprise a power source disposed within the cavity of the housing.

Alternatively or additionally to any of the examples above, in another example, the grooming tool may further comprise a power source disposed exterior to the cavity of the housing.

Alternatively or additionally to any of the examples above, in another example, the grooming tool may further comprise an ultrasonic device disposed within the cavity of the housing.

Alternatively or additionally to any of the examples above, in another example, the grooming tool may further comprise a sonic device disposed within the cavity of the housing.

Alternatively or additionally to any of the examples above, in another example, the grooming tool may further comprise a gear assembly disposed within the cavity of the housing, the gear assembly operably coupled to the motor and the first and second pads.

Alternatively or additionally to any of the examples above, in another example, the grooming tool may further comprise one or more intermediate layers positioned between the plurality of cleaning fibers and the first and second pads.

Alternatively or additionally to any of the examples above, in another example, the one or more intermediate layers may be formed from a compressible material.

Alternatively or additionally to any of the examples above, in another example, the grooming tool may further comprise a lotion dispenser.

Alternatively or additionally to any of the examples above, in another example, the lotion dispenser may be disposed within the cavity of the housing.

Alternatively or additionally to any of the examples above, in another example, may be disposed exterior to the housing.

Alternatively or additionally to any of the examples above, in another example, the grooming tool may further comprise one or more infrared lights.

Alternatively or additionally to any of the examples above, in another example, the grooming tool may further comprise an air suction and/or blower system.

In another example, a grooming system for grooming an animal may comprise a grooming tool. The grooming tool may comprise a first housing defining a cavity, a first rotatable pad and a second rotatable pad each forming a portion of a bottom surface of the first housing, the first and second rotatable pad configured to rotate relative to the first housing, a plurality of cleaning fibers extending from each of the first and second rotatable pads, a motor, and a gear assembly operably coupled to the first and second rotatable pads and the motor. The first rotatable pad may be configured to rotate in a first direction relative to a center of the bottom surface of the first housing and the second rotatable pad may be configured to rotate in a second direction opposite the first direction.

Alternatively or additionally to any of the examples above, in another example, the motor may be disposed within the cavity of the first housing.

Alternatively or additionally to any of the examples above, in another example, the motor may be disposed in a second housing separate from the first housing.

Additional non-limiting examples may take the form of a method of using any of the above (or below) described grooming tools and/or systems to groom an animal by placing the grooming tool against the animal's body, activating the motor, pad and/or brush, and moving the grooming tool along the animal's body.

Additional non-limiting examples may take the form of a method of securing, removing, and/or adjusting components of any of the above (or below) described grooming tools and/or systems.

The above summary of some example embodiments is not intended to describe each disclosed embodiment or every implementation of the invention.

### BRIEF DESCRIPTION OF THE DRAWINGS

The invention may be more completely understood in consideration of the following detailed description of various embodiments in connection with the accompanying drawings, in which:

FIG. 1 is a perspective view of an illustrative mechanized grooming tool;

FIG. 2A is an end view of the mechanized grooming tool of FIG. 1;

FIG. 2B is a cross-sectional view of the illustrative grooming tool of FIG. 2A, taken at line 2B-2B of FIG. 2A;

FIG. 3 is a schematic block diagram of the mechanized grooming tool of FIG. 1;

FIG. 4 is a schematic view of an illustrative gear assembly for use with a mechanized grooming tool;

FIG. 5A is a perspective view of another an illustrative gear assembly for use with a mechanized grooming tool;

FIG. 5B is a partial cross-sectional view of the gear assembly of FIG. 5A;

FIG. 6A is an end view of another illustrative mechanized grooming tool;

FIG. 6B is a cross-sectional view of the mechanized grooming tool of FIG. 6 taken at line 6B-6B of FIG. 6A;

FIG. 7 is an end view of another illustrative mechanized grooming tool; and

FIG. 8 a perspective view of an illustrative grooming system including an extendable handle and a grooming tool.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the spirit and scope of the invention.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimension ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

While the disclosure will be discussed relative to horses, it should be understood that the tools and embodiments disclosed herein are suitable for brushing animals that have fur including livestock, horses and in some cases companion animals such as cats and dogs.

Horses are groomed for several different reasons. In addition to keeping the horse clean and comfortable, grooming may also help distribute the horse's natural skin oil over the coat, improve circulation, promote healthy hair growth, allow for a close examination of the horse, and/or provide training in obedience and manners. There are various steps and manual tools involved in the process of grooming a horse. The first step may be to place a rubber curry comb in small (about the size of your palm) against the body of the animal and use circular motions to loosen excess dirt and mud. The process typically starts at the neck and the groomer then works down each side of the horse. This process is often continued using a hard and/or stiff brush in short, brisk strokes to remove excess dirt and mud that was loosened with the curry comb. The grooming process may then be continued with a third, and sometimes a fourth, brush with finer and/or softer hairs.

This may be a long process whereby the shoulder of the groomer is lifted while making repetitive circular motions or repetitive stroking motions with the arm lifted above the shoulder in a large portion of the process. Consistent grooming of a horse may result in repetitive strain injuries to the shoulder of the groomer. The present disclosure is directed towards a grooming system which mechanizes at least a portion of the grooming tool. In some embodiments, one advantage of the disclosure is to provide tools, systems and methods that may reduce repetitive motion and/or limit the need to raise one's arm above the shoulder.

Different grooming tools may utilize different teeth, bristles, fibers, hairs, etc. to achieve a desired outcome. For example, a curry comb may include rows of metallic, rubber, or plastic teeth or serrated ridges. In another example, hard brushes may utilize synthetic plastic bristles or natural fibers such as, but not limited to, bassine or palmyra. In yet another example, soft brushes may utilize synthetic materials such as, but not limited to, nylon or other plastics or organic fibers such as, but not limited to, union fiber, goat hair, or Ixtle. Further, the length, diameter, material, stiffness, etc. of the teeth, bristles, fibers, hairs, etc. may be varied from tool to tool. As used herein, a cleaning “fiber” may refer to single teeth (such as, but not limited to, those on a curry comb), single bristles, fibers, or hairs, or groups or clusters of bristles, fibers, or hairs.

In some embodiments, the grooming system described herein may be at least partially mechanized to reduce and/or eliminate the repetitive motion required by the groomer and/or the strain imparted on the groomer during the grooming process. For example, the present grooming system may be mechanized so that at least some of the cleaning fiber are mechanically rotated independent of the actions of the groomer. In other words, in some examples, the groomer's hand does not need to be rotated or moved in a circular manner to affect the rotation of the grooming fiber. In some cases, the grooming fiber may be moved in different directions and/or speeds, individually or in groups, to allow the fiber to contact a same region of fur from different directions. The grooming system may further include other features to improve the effectiveness of grooming and/or the ergonomics of the grooming process, such as, but not limited to, an elongated handle.

Relative terms such as “top” and “bottom”, variants thereof, and the like, may be generally be considered with respect to the positioning, direction, and/or operation of various elements relative to a user/operator/manipulator of the device, wherein “top” indicates or refers to closer to or toward the user and “bottom” indicates or refers to farther from or away from the user (e.g., closer to the animal being groomed).

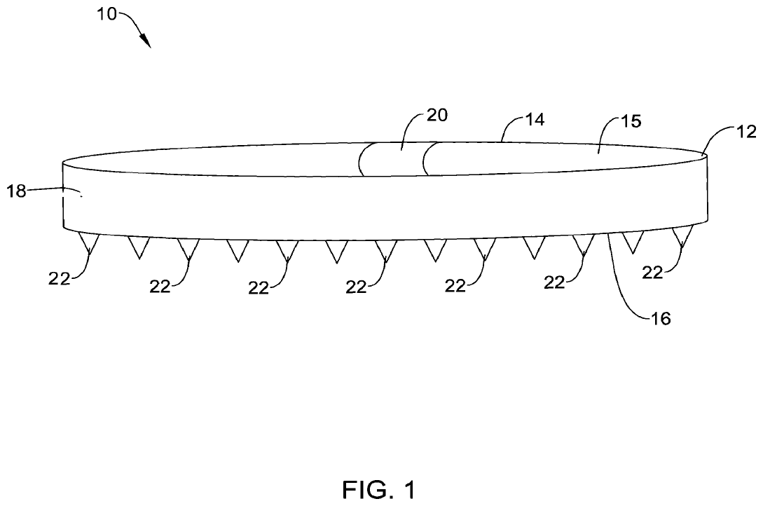

FIG. 1 is a perspective view of an illustrative mechanized grooming tool 10 in accordance with the present disclosure. While the grooming tool 10 is described with respect to grooming a horse, the grooming tool 10 is not so limited. The grooming tool 10 may be used on other animals, domesticated or non-domesticated, as desired. Further, while reference is made to some particular grooming tools, the features described herein may be applied to other grooming tools as well. Some illustrative horse grooming tools may include, but are not limited to, oval massage curry brushes, mane combs, tail combs, hoof picks (with or without a brush), soft brushes, jelly scrubbers, spring curry combs, hard brushes, plastic massage brushes, contoured sweat scraper, etc.

The grooming tool 10 may include a housing 12 having a gripping edge 14 and a grooming edge 16. A sidewall 18 extends between the gripping edge 14 and the contact or grooming edge 16. Generally, during the grooming process the contact or grooming edge 16 is the side of the grooming tool 10 positioned closest to the animal being groomed. The shape of the sidewall 18 may vary based on the shape of the housing 12. In the illustrated embodiment, the sidewall 18 may be a continuous wall or surface extending about an entirety of the perimeter of the hosing 12. In some cases, the sidewall 18 may be fixedly secured to or formed as a single unitary structure with the gripping edge 14. A top surface 15 extends between the sidewall 18 adjacent the gripping edge 14. The sidewall 18 may be adjacent to a grooming surface (not explicitly shown) but not secured thereto. This may allow a grooming surface to rotate relative to the sidewall 18. In other cases, the sidewall 18 may be fixedly secured to or formed as a single unitary structure with a grooming surface. Collectively, the top surface 15, bottom surface, and sidewall 18 may define an internal cavity. As will be described in more detail herein, the cavity may house one or more motors and/or power supplies. In some cases, the housing 12 may have a generally cylindrical configuration. However, other 3-dimensional shapes having varying cross-sectional shapes, such as, but not limited to, oval, rectangular, elliptical, etc., may be used as desired.

A strap 20 may extend across the top surface 15 of the grooming tool 10. In some cases, the strap 20 may extend between lateral sides of the housing 12 and is configured to receive the user's hand between the bottom surface of the strap 20 and the top surface 15 of the housing 12. In some embodiments, the strap 20 may be formed from an elastic material. Other synthetic or natural materials may be used, as desired. In some embodiments, the strap may be a replaceable feature, to allow custom fit to a user's hand and/or to allow repair of a broken strap, for example, by attaching the strap 20 with snaps, screws, etc. In some embodiments, the strap 20 may be replaced with other gripping mechanisms, such as, but not limited to, a handle. For example, the handle may be an elongate bar configured to be gripped by the user. In yet other cases, in addition to or in place of a handle or strap 20, the housing 12 may include one or more depressions or gripping regions formed in opposing sides of the sidewall 18 thereof for receiving the user's fingers. It is further contemplated that the top surface 15 of the housing 12 may be curved to provide a surface which is contoured to a user's palm, although this is not required.

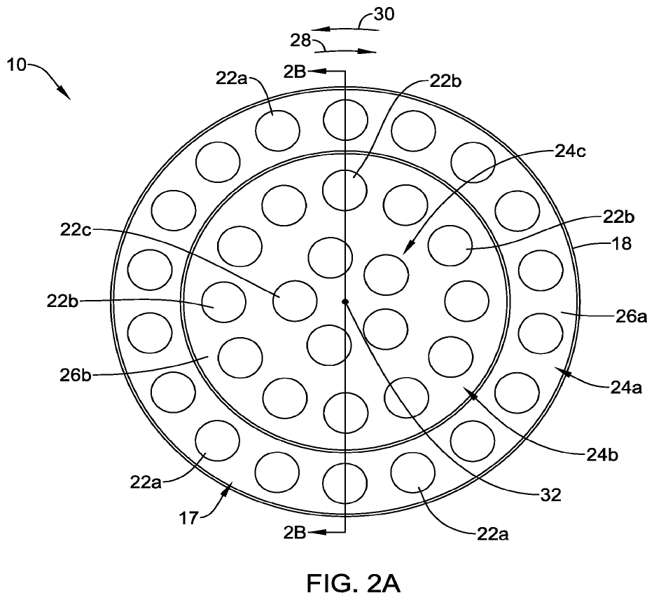

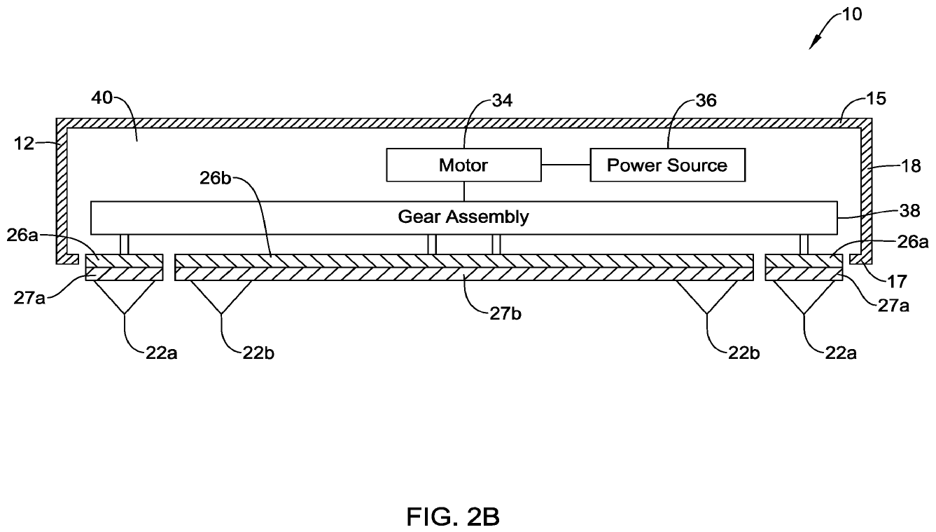

Referring additionally to FIG. 2A, which illustrates a bottom view of the grooming tool 10, the grooming tool 10 may further include one or more cleaning fibers or groups of cleaning fibers 22a, 22b, 22c (collectively, 22) extending away from a bottom surface 17 thereof. It should be understood that not every cleaning fiber 22 is identified with a reference numeral. In the illustrated embodiment, the cleaning fibers 22 are illustrated as singular teeth; however, this is not required. The cleaning fibers 22 may be different types of hairs or bristles, groups of hairs or bristles, rubber teeth, etc. When the grooming tool 10 includes hairs or bristles, the hairs or bristles may be arranged in a plurality of sets of hairs or bristles. For example, while not explicitly shown, each cleaning fiber 22 may include a plurality of bristles or hairs. When the grooming tool 10 includes teeth (rubber or otherwise), each cleaning fiber 22 may be a single unitary structure having a desired shape (e.g., conical, pyramidal, hemispherical, etc.).

In some cases, the cleaning fibers 22 may be arranged in groups 24a, 24b, 24c forming concentric circles. For example, a first group 24a of cleaning fibers 22a may form an outer circle, a second group 24b of cleaning fibers 22b may form an intermediate circle, and a third group 24c of cleaning fibers 22c may form an inner circle. This is just one example. The cleaning fibers 22 may be arranged in any pattern that facilitates the function of the invention. For example, the grooming tool 10 may include fewer than three groups of cleaning fibers 22 or more than three groups of cleaning fibers 22. Further, the cleaning fibers 22 need not be arranged in concentric circles. For example, the cleaning fibers 22 may be arranged in various patterned or non-patterned configurations. Some additional, but non-limiting configurations will be described in more detail herein.

The bottom surface 17 of the grooming tool 10 may be adjacent to the grooming edge 16 of the housing 12 and may be formed from one or more rotating pads 26a, 26b (collectively, 26). In some cases, the pads 26 may form the bottom surface 17 of the grooming tool 10. The pads 26 may have a configuration which allow the pads 26 to rotate collectively or individually about a center 32 of the bottom surface 17. For example, the pads 26 may be generally circular (26b), generally annular (26a), or combinations thereof. More parts may be included, such as by having a central circular pad 26b, surrounded by two or more annular pads 26a, each moving relative to the other and/or relative to the handle/strap of the grooming tool 10. However, other shapes may also be used. The pads 26 may rotate in a plane generally parallel to the grooming edge 16 of the housing. As will be described in more detail herein, the pads 26 may be coupled to one or more motors or drive gears which cause the pads 26 to rotate, as shown at arrows 28, 30. In the illustrative embodiment, a first pad 26a may have a generally annular configuration while a second pad 26b may have a generally circular configuration. The second pad 26b may be disposed radially inward of the first pad 26a.

The orientation of the cleaning fibers 22 relative to the pads 26 may be fixed or, alternatively, the cleaning fibers 22 may rotate individually in addition to the pads 26 rotating relative to one another and or the handle of the grooming tool 10. As the pads 26 rotate, the entire grooming tool 10 may not need to be rotated to cause the cleaning fibers 22 to make a rotating movement on the coat of a horse. That is, the user need not make a rotating motion with the grooming tool 10, though the user may choose to do so as desired. It is contemplated that the pads 26 may be rotated in a clockwise direction 28, a counterclockwise direction 30, or combinations thereof.

In one illustrative example, the pads 26 may rotate in a same direction, such as clockwise 28 or counterclockwise 30. It is contemplated that if the pads 26 (and thus the cleaning fibers 22) rotate in a same direction about the center 32, only a single pad 26 may be provided. When the pad(s) 26 are rotated in a single direction, a torque may be applied to the hand of the groomer thus requiring the groomer to apply a counter torque to the grooming tool 10 to keep the grooming tool 10 steady. To reduce the net torque generated by the rotating pads, counter-rotating pads 26 may be used. For example, the first pad 26a may rotate in a first direction and the second pad 26b may rotate in a second direction opposite the first direction. In some cases, there may be an equal number of pads 26 rotating in the first direction and the second direction. In other cases, the number of pads 26 rotating in the first and second direction may be different. For example, a traditional curry comb has three elliptical rings of rubber teeth. When three rings of cleaning fibers 22 are present, the outermost ring may be rotated in a first direction and the two inner rings rotated in a second direction, opposite the first direction. Other permutations will be appreciated by the reader and are included in the scope of the disclosure.

In some embodiments, the pads 26 may be releasably secured relative to the housing 12. This may allow for different pads 26 having different style cleaning fibers 22 to be used with the same housing 12. For example, a groomer may begin the grooming process with a pad or pads 26 having rubber teeth, similar to a rubber curry comb. Once that stage of grooming is complete, the groomer may remove the pad 26 having the rubber teeth and replace it with one having stiff bristles. Once that stage of grooming is complete, the groomer may remove the pad with the stiff bristles and replace it with one having pliable bristles. This may be repeated as necessary to complete the grooming process.

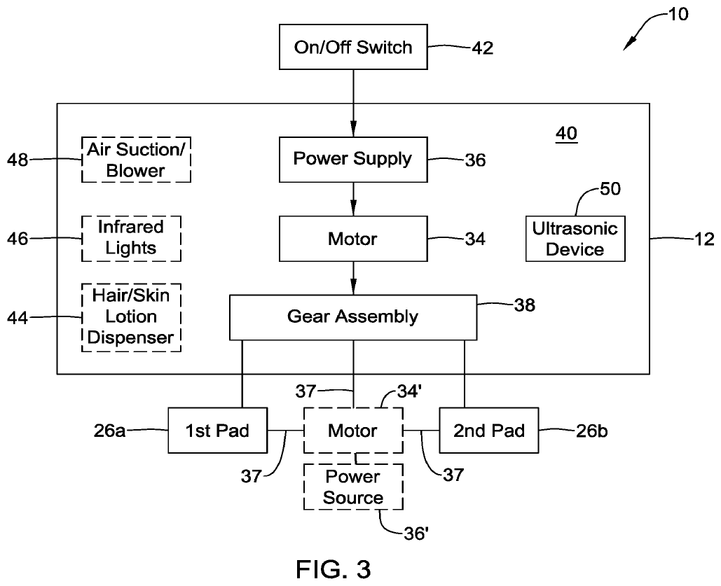

Reference will now be made to both FIG. 2B and FIG. 3. FIG. 2B is a cross-sectional view of the illustrative grooming tool 10, taken at line 2B-2B of FIG. 2A. FIG. 3 is a schematic block diagram of an illustrative grooming tool 10 having two rotating pads 26a, 26b. In some cases, it may be desirable for the cleaning fibers 22 to follow the contour of the animal being groomed. It is contemplated that at least a portion of the pads 26 may be made of a compressible material, such as, but not limited to, silicone, rubber, silicone rubber, etc. In some cases, the compressible material may be provided as an intermediate layer 27a, 27b between the cleaning fibers 22 and the pads 26a, 26b. In other cases, the pads 26 may be formed entirely from a compressible material. This may allow the grooming surface to conform to the body of the animal being groomed.

As described above, the top surface 15, bottom surface 17, and sidewall 18 of the housing 12 may define an internal cavity 40. The cavity 40 may house one or more direct current (DC) motors 34 and a power supply 36, although this is not required. As will be described in more detail herein, the motor(s) 34 and/or power supply 36 may be positioned exterior to the housing 12. In the illustrated embodiment, a single motor 34 is provided to cause the rotation of each pad 26. However, this is not required. It is contemplated that more than one motor may be used to rotate the pads 26, if so desired.

The motor 34 may be powered by a power supply 36 also disposed within the housing 12. In some cases, the power supply 36 may be a battery, such as a primary cell or a rechargeable battery. In one example, the power supply 36 may be a rechargeable lithium battery. While the power supply 36 is shown and described as located within the cavity 40 of the housing 12, it is not necessary to carry the power supply 36 within the brush. For example, a cable and cord may be used to electrically couple an external battery pack to the grooming tool 10. This may allow a groomer to clip a battery pack to their belt which may reduce the overall weight and/or size of the grooming tool 10. In other examples, the power supply 36 may be provided in a handle (as will be described in more detail herein). In yet other examples, the motor 34 may be configured to receive power from an exterior power supply via a cord (not explicitly shown) and/or adaptor, such as by coupling to a wall outlet. The power supply 36 may be activated by an on/off or power switch 42 located in an exterior of the grooming tool 10.

When the power supply is a battery, the motor 34 may be a DC motor operating on a voltage in the range of 6 Volts (V) to about 36V. However, voltages outside the range of 6V to 36V may be used depending on the power supply 26. As most DC motors run at high speed (e.g., in the range of several hundred to thousands of Hertz) at low torque, it may be desirable to reduce the rotational speed of the axis while increasing the torque to more closely simulate the rotational speed of the grooming tool 10 that may be achieved with manual grooming (e.g., in the range of about 0.5 to 4 rotations per second). This may be achieved by providing the motor 34 with a reduction gear set, gearbox, or other gear assembly 38. An illustrative reduction gear set may include, but is not limited to, a worm wheel, planetary gears, helical gears, spur gears, combinations thereof, etc. It is contemplated that the gear arrangement 38 may be selected such that each pad 26 may be rotated at different speeds, if so desired.

In some alternative designs, power to actuate the brushes may be provided by a non-electrical input, such as by pneumatic or forced fluid (hydraulic) mechanisms. For example, a pump system may be carried or worn by the groomer, or simply placed near the animal to be groomed, rather than relying solely on electrical power. It is contemplated that in addition to powering the brushes, the fluid can also be released by the cleaning fibers to facilitate cleaning the animal and/or the grooming tool 10.

In another example, the motor 34′ as well as the power source 36′ may be housed exterior to the housing 12 of the grooming tool 10. For example, the motor 34′ and the power source 36′ may be housed within a housing separate from the housing 12 of the grooming tool 10 and worn or clipped on the belt of the user. The motor 34′ may be coupled to the gear assembly 38′ or rotating pads 26′ via a torque wire or flexible motor shaft 37. This may allow even the gear assembly 38 to be external to (not explicitly shown) the grooming tool 10. It is contemplated that this may reduce the volume of the noise in close proximity to the animal. Especially in a case where the grooming tool comes close to the head of the animal, it might be advantageous to have the motor exterior to or remote from the housing 12 of the grooming tool 10. It is further contemplated that locating the motor 34 exterior to the housing 12 may also allow for the use of a heavier motor

In still other alternative designs, rather than one motor to power each of the first and second pads 26, there may be two or more motors that can independently actuate pads, such as by having a first motor coupled to a first pad or a first set of brushes, and a second motor coupled to a second pad or a second set of brushes. The gear set may include manually actuatable, or electrically controllable, clutch mechanisms to allow disengagement of one of the pads or sets of brushes from the motor, as for example may be desirable to provide spot treatment. For example, a manually actuatable external switch or toggle may be provided to disengage a gear by depressing or raising the gear out of the plane of other gears with which it would otherwise be engaged with.

In some cases, the grooming tool 10 may be provided with additional functionalities that may facilitate the grooming of the horse. For example, the grooming tool 10 may include a hair/skin lotion dispenser 44. In some cases, a lotion reservoir may be located within the housing 12 of the grooming tool 10 with the lotion dispensed in response to actuation of a button. In other cases, the lotion dispenser 44 may be a separate component that is releasably coupled to the grooming tool 10. For example, a spray system may be releasably coupled to the grooming tool. Alternatively, a first end of a feed tube may be mounted to the grooming tool 10 and a second end mounted to a remote reservoir that provides a larger volume of reserve lotion. In some cases, a remote reservoir may be provided in an external belt component which may also house other components.

In another example, the grooming tool 10 may include one or more infrared light sources 46 to provide heat to the skin and/or muscles of the horse. In some cases, the infrared light sources may be positioned in the pads 26 and powered by the power supply 36. While not explicitly shown, a separate on/off switch may be provided for the infrared light sources 46.

In yet another example, the grooming tool 10 may include an air suction and/or blower system 48. A blower system 48 may help to dry the hairs during the grooming process while a suction system 48 may help remove dirt and debris. It is contemplated that holes or apertures (not explicitly shown) may be provided in the pads 26 to allow air to enter/exit the housing 12.

It is further contemplated that the grooming tool 10 may be provided with an ultrasonic or sonic device 50. The ultrasonic device 50 may generate a high frequency vibration (e.g., in the range of 100 hertz (Hz) to about 10 kHz) of the cleaning fibers 22. The vibration may help to shake loose any solid debris (e.g., mud) that is stuck in the horse's coat. It is contemplated that while not explicitly shown, a separate on/off switch may be provided for the ultrasonic device 50. In some embodiments, the ultrasonic device 50 may be provided in embodiments where rotation may not be desired. For example, the inclusion of an ultrasonic device into a mane or tail comb may improve the performance of these grooming tools. It is contemplated that a vibrating comb may more efficiently untangle the mane as hairs will flow easier and faster through the vibrating comb compared to a manual comb operation. For example, in the situation of having a comb in a network of entangled hairs, adding vibration will pass kinetic energy from the combs to the hairs, causing all hairs to start vibrating relative to each other and thus reducing the friction. When an ultrasonic device, or vibration system, is provided independent of the rotating pads 26, the ultrasonic device may be provided in a handle of the grooming tool along with a power source (such as, but not limited to, a rechargeable battery). In some cases, a voice coil actuator may be used. This may allow several vibrational frequencies to be used. The handle/grip of the grooming tool 10 may include padding or dampening material to allow vibration to be applied to the animal, without the user's hand experiencing the same, improving comfort.

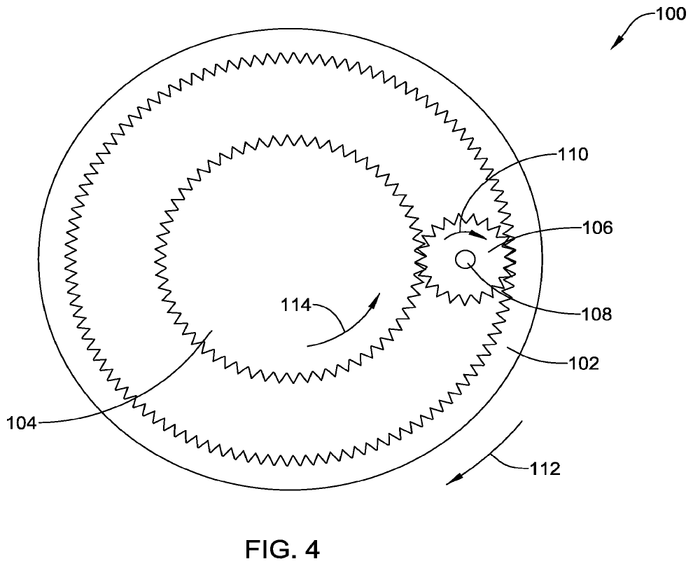

It is contemplated that a single motor may be used to drive the pads 26 in a single direction or in opposing directions. FIG. 4 is a schematic view an illustrative gear assembly 100 that may be used to drive the pads 26 in opposing directions. The illustrative gear assembly 100 may include an outer ring gear 102 with the teeth facing radially inward. A central gear 104 with radially outward teeth is positioned at a center of the ring gear 102. A motor gear 106 with radially outward teeth is positioned between the ring gear 102 and the central gear 104. The motor gear 106 is operably coupled to the motor via a carrier or shaft 108. As the motor rotates the motor gear 106, as shown at arrow 110, the outer ring is driven in a first direction, as shown at arrow 112, and the central gear 104 is driving in a second direction, opposite the first, as shown at arrow 114. In the illustrative embodiment of FIG. 2, the first pad 26a may be coupled to the ring gear 102 to drive the first pad 26a in a first direction and the second pad 26b may be operably coupled to the central gear 104 to drive the second pad 26b in a second direction.

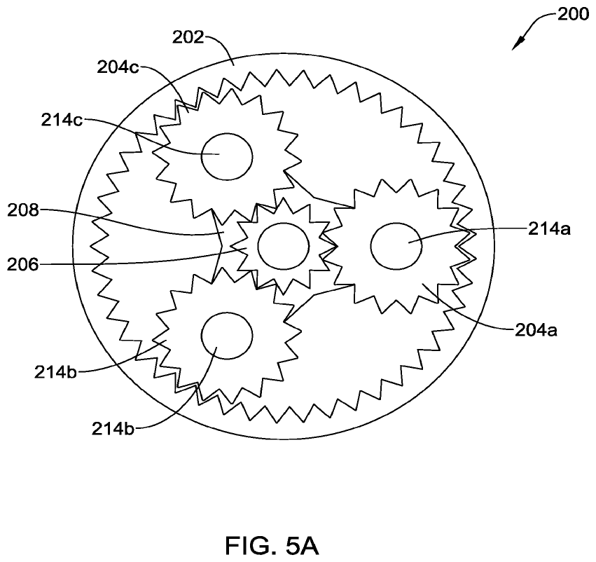

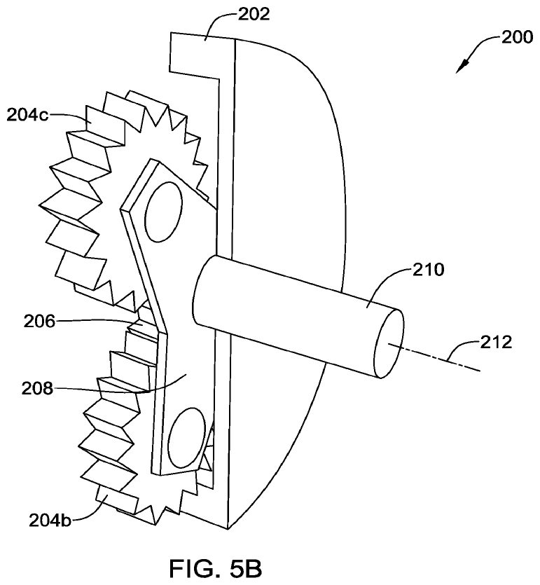

FIG. 5A is a schematic view of another illustrative gear assembly 200 that may be used to drive multiple pads 26. FIG. 5B is a perspective view of the illustrative gear assembly 200 of FIG. 5A taken in partial cross-section. The illustrative gear assembly 200 may include an outer ring gear 202. A carrier 208 may be coupled to a plurality of planet gears 204a, 204b, 204c (collectively, 204) and a central sun gear 206. The carrier 208 connects the planet gears 204 and the sun gear 206. The carrier 208 may rotate to carry the planet gears 204 around the sun gear 206. An elongate shaft 210 may extend from the carrier 208 and through the ring gear 202. The elongate shaft 210 may be coupled to the drive output of the motor 34 such that rotation of the drive output is translated into rotation of the planet gears 204 and the sun gear 206. For example, the gear assembly 200 may be positioned between the motor 34 and the pads 26 such that the drive output of the motor 34 is coupled to the elongate shaft 210 of the gear assembly 200 and the gears 204, 206 are coupled to the pads 26. In the illustrative embodiment, one or more pads 26 may be coupled relative to the planet gears 204 and/or sun gear 206. Depending on where the pads 26 are coupled relative to the gears 204, 206, the pads may be rotated about a central axis 212 of the gear assembly 200 and/or a central axis of each of the planet gears 204. This is just an example. It is contemplated that any number of gear configurations may be used to achieve the desired rotational pattern of the pads 26 and/or cleaning fibers 22.

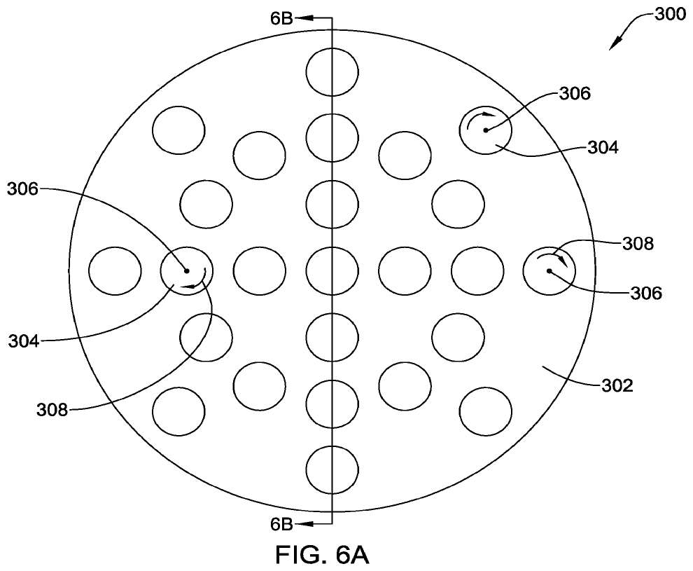

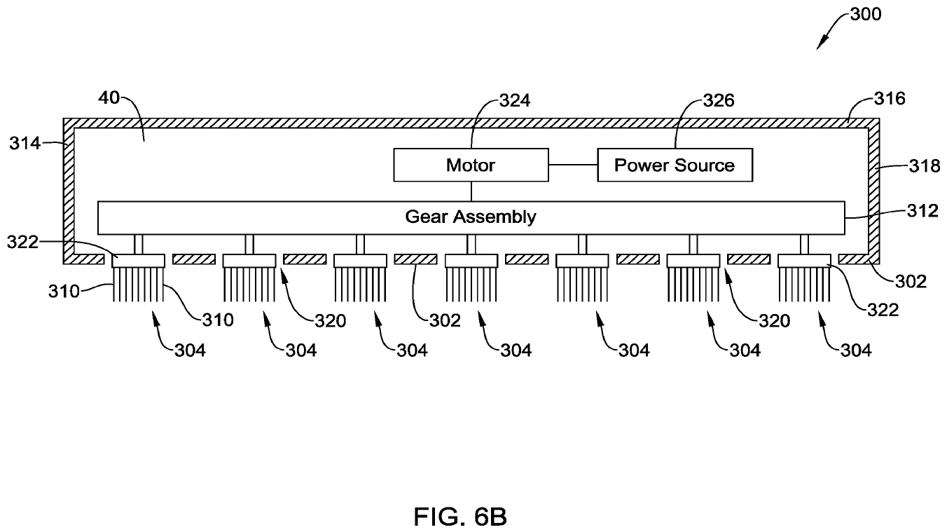

FIG. 6A is a view of a grooming surface of another mechanized grooming tool 300. FIG. 6B illustrates a schematic cross-sectional view of the grooming tool 300 taken at line 6B-6B of FIG. 6A. The grooming tool 300 may be similar in form and function to the grooming tool 10 described herein. The grooming tool 300 may include a housing 314 having a top surface 316 and a bottom surface 302. A sidewall 318 extends between the top surface 316 and the bottom surface 302. While not explicitly shown, the grooming tool 300 may include a strap, a handle, or other features to facilitate gripping of the grooming tool 300.

The grooming tool 300 may include one or more cleaning fibers 304 extending away from a bottom surface 302 thereof. It should be understood that not every cleaning fiber 304 is identified with a reference numeral. The one or more cleaning fibers 304 may extend through one or more openings 320 extending through a thickness of the bottom surface 302. The cleaning fibers 304 may be coupled to one or more pads 322. In some cases, each cleaning fiber 304 may be coupled to its own unique pad 322. In other embodiments, two or more cleaning fibers 304 may be coupled to a same pad 322.

The cleaning fibers 304 may include multiple bristles 310 clustered together to form a cleaning fiber 304. As described above, the cleaning fibers 304 may be different types of hairs or bristles, groups of hairs or bristles, rubber teeth, etc. When the grooming tool 300 includes hairs or bristles, the hairs or bristles may be arranged in a plurality of sets of hairs or bristles. For example, while not explicitly shown, each cleaning fiber 304 may include a plurality of bristles or hairs. When the grooming tool 300 includes teeth (rubber or otherwise), each cleaning fiber 304 may be a single unitary structure having a desired shape (e.g., conical, pyramidal, hemispherical, etc.).

In some cases, the cleaning fibers 304 may be spaced and extend from the bottom surface 302 of the grooming tool 300 in any manner desired. For example, the cleaning fibers 304 may be arranged in various patterned or non-patterned configurations. The cleaning fibers 304 may be coupled to one or more gears forming a gear assembly 312 disposed within the housing 314 such that the cleaning fibers 304 are configured to rotate about a center 306 of the cleaning fiber 304, as shown at arrow 308. The housing 314 may house one or more direct current (DC) motors 324 and a power supply 326, although this is not required.

In one example, each cleaning fiber 304 may be configured to individually rotate about its center 306. While each of the cleaning fibers 304 are illustrated as rotating 308 in a generally clockwise direction, the cleaning fibers 304 may be configured to rotate in a counterclockwise direction. It is further contemplated that some of the cleaning fibers 304 may rotate in first direction and some of the cleaning fibers 304 may rotate in a second direction, opposite from the first direction. It is contemplated that the gear arrangement may be selected such that each cleaning FIG. 304 can move in different direction, at different speeds and/or in groups, if so desired. For example, a speed of rotation may be varied by varying a size of a gear. Groups of cleaning fibers 304 can be rotated using a same gear. In yet other examples, the direction of rotation can be varied through the configuration of the gear assembly 312 and/or through the use of more than one motor or drive assembly.

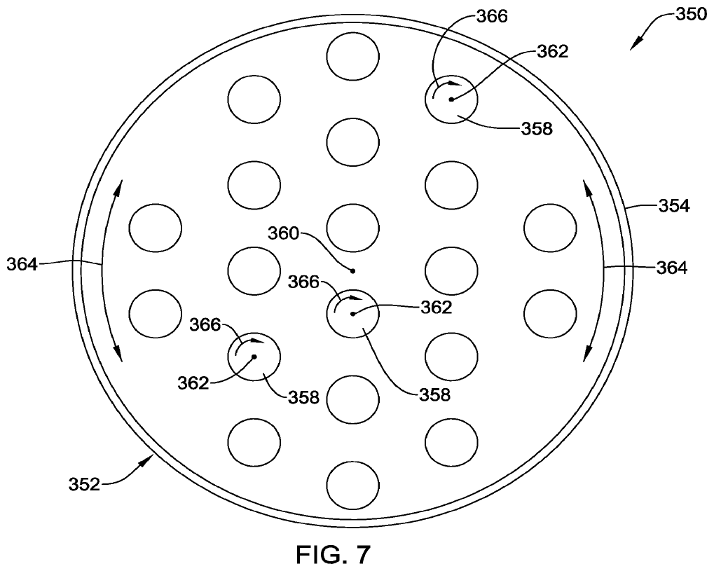

FIG. 7 is a view of a grooming surface of another mechanized grooming tool 350. The grooming tool 350 may be similar in form and function to the grooming tool 10 described herein. The grooming tool 350 may include one or more cleaning fibers 358 extending away from a bottom surface 352 thereof. It should be understood that not every cleaning fiber 358 is identified with a reference numeral. The cleaning fibers 358 may be different types of hairs or bristles, groups of hairs or bristles, rubber teeth, etc. When the grooming tool 350 includes hairs or bristles, the hairs or bristles may be arranged in a plurality of sets of hairs or bristles. For example, while not explicitly shown, each cleaning fiber 358 may include a plurality of bristles or hairs. When the grooming tool 350 includes teeth (rubber or otherwise), each cleaning fiber 358 may be a single unitary structure having a desired shape (e.g., conical, pyramidal, hemispherical, etc.).

In some cases, the cleaning fibers 358 may be spaced about the bottom surface 352 of the grooming tool 350 in any manner desired. For example, the cleaning fibers 358 may be arranged in various patterned or non-patterned configurations. The cleaning fibers 358 may be coupled to one or more gears such that the cleaning fibers 358 are configured to rotate about a center 362 of the cleaning fiber 358, as shown at arrow 366. For example, each cleaning fiber 358 may be configured to individually rotate about its center 362. While each of the cleaning fibers 358 are illustrated as rotating around 366 in a generally clockwise direction, the cleaning fibers 358 may be configured to rotate in a counterclockwise direction. It is further contemplated that some of the cleaning fibers 358 may rotate in first direction and some of the cleaning fibers 358 may rotate in a second direction, opposite from the first direction. It is contemplated that the gear arrangement may be selected such that each cleaning FIG. 358 can move in different direction, at different speeds and/or in groups, if so desired

It is further contemplated that the bottom surface 352 of the grooming tool 350 may be formed from one or more rotating pads 356. In some cases, the pads 356 may form the bottom surface 352 of the grooming tool 350. The pad 356 may have a generally circular configuration which allows the pad 356 to rotate about a center 360 of the bottom surface 352. For example, the pad 356 may be coupled to one or more motors or drive gears which cause the pads 356 to rotate, as shown at arrow 354. In some cases, the pad 356 may be configured to oscillate between rotation in opposing direction. In some cases, the pad 356 may be configured to rotate less than 360°. In the illustrative example, the cleaning fibers 358 may rotate about their own center as well as at least partially about the center 360 of the pad 356.

It is contemplated that the grooming tools 10, 300, 350 may allow the groomer to slowly move the grooming tool 10, 300, 350 from head to tail in smooth linear pathway while the internal motor 34 and gear assembly 38 produce circular movement of the cleaning fibers 22, 304, 358. The cleaning fibers 22, 304, 358 may be rotated about a center of the grooming tool 10, 300, 350 and/or a center of the cleaning fibers 22, 304, 358 themselves.

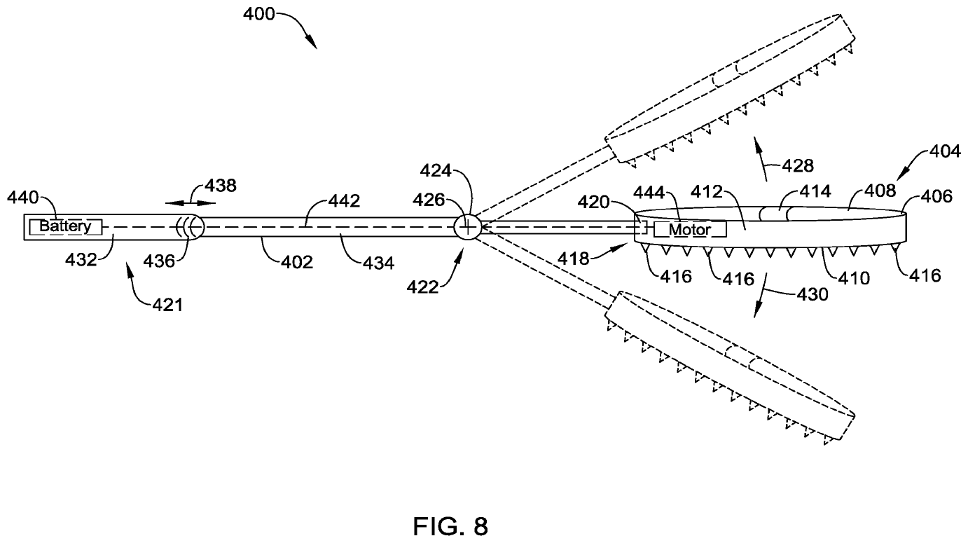

In some embodiments, a hand extension or extendable handle may be releasably secured to the grooming tool 10, 300, 350 to allow the groomer to keep the arms low and reduce the likelihood of a shoulder injury. FIG. 8 illustrates a perspective view of an illustrative grooming system 400 including an extendable handle 402 and a grooming tool 404. The grooming tool 404 may be similar in form and function to the grooming tool 10 described herein. The grooming tool 404 may include a housing 406 having a top surface 408 and a bottom surface 410. A sidewall 412 extends between the top surface 408 and the bottom surface 410. In some cases, the sidewall 412 may be fixedly secured to or formed as a single unitary structure with the top surface 408. In some cases, the sidewall 412 may be adjacent to the bottom surface 410 but not secured thereto. This may allow the bottom surface 410 to rotate relative to the sidewall 412. In other cases, the sidewall 412 may be fixedly secured to or formed as a single unitary structure with the bottom surface 410. Collectively, the top surface 408, bottom surface 410, and sidewall 412 may define an internal cavity. As described above, the cavity may house one or more motors, gear assemblies and/or power supplies.

A strap 414 may extend across the top surface 408 of the grooming tool 404. In some cases, the strap 414 may extend between lateral sides of the housing 406 and is configured to receive the user's hand between the bottom surface of the strap 414 and the top surface 408 of the housing 406. In some cases, the strap 414 may be omitted. In yet other examples, in addition to or in place of the strap 414, the housing 408 may include one or more depressions or gripping regions formed in opposing sides of the sidewall 412 thereof for receiving the user's fingers. It is further contemplated that the top surface 408 of the housing 406 may be curved to provide a surface which is contoured to a user's palm, although this is not required. It is contemplated that the strap 414 and/or gripping regions may allow the groomer to use the grooming tool 404 without the extendable handle 402.

The grooming tool 404 may further include one or more cleaning fibers or groups of cleaning fibers 416 extending away from the bottom surface 410 thereof. It should be understood that not every cleaning fiber 416 is identified with a reference numeral. The cleaning fibers 416 may be different types of hairs or bristles, groups of hairs or bristles, rubber teeth, etc. When the grooming tool 404 includes hairs or bristles, the hairs or bristles may be arranged in a plurality of sets of hairs or bristles. For example, while not explicitly shown, each cleaning fiber 416 may include a plurality of bristles or hairs. When the grooming tool 404 includes teeth (rubber or otherwise), each cleaning fiber 416 may be a single unitary structure having a desired shape (e.g., conical, pyramidal, hemispherical, etc.). The cleaning fibers 416 may be positioned in any of the arrangements described herein. Further, the cleaning fibers 416 may be configured to rotate about a center of the bottom surface 410 and/or a center of the cleaning fibers 416.

The extendable handle 402 may be an elongate handle configured to be releasably secured to the grooming tool 404. For example, a distal end 418 of the handle 402 may be configured to be received within a mating recess 420 formed in the housing 406 of the grooming tool 404. In some cases, the distal end 418 of the handle 402 may be threaded. The recess 420 may be similarly threaded such that the distal end 418 of the handle 402 may be threadably received therein. Thus, the grooming tool 404 may be releasably secured to the handle 402 such that the grooming tool 404 may be used with or without the handle 402, as desired. According to the embodiment, alternative systems for securing the handle to the housing used in the art are suitable for use and within the scope of the invention.

The handle 402 may include an articulating distal end region 422 having a pivoting hinge 424. The hinge 424 may allow an angle of the grooming tool 404 to be adjusted relative to a longitudinal axis of a proximal end region 421. In some cases, a fixation mechanism 426 may be used to secure the hinge 424 in a desired position. It is contemplated that any fixation mechanism that can secure the hinge in a desired orientation may be used. For example, the fixation mechanism 426 may be screws, bolts, bolts with handwheels, pins, etc. In some cases, the fixation mechanism 426 may be actuated through rotation thereof. To reposition the grooming tool 404, the user may release the fixation mechanism 426, move the grooming tool 404 to the desired orientation, as shown at arrows 428, 430, and re-secure the fixation mechanism 426. It is contemplated that the range of motion of the grooming tool 404 may be determined by the range of motion of the hinge 424. In some cases, the range of motion may be 180º or less.

The extendable handle 402 may be configured to expand or contract between a plurality of lengths. For example, the handle 402 may be adjustable between a minimum length of 6 inches and a maximum length of 24 inches. However, the length may be less than 6 inches or greater than 24 inches, as desired. In some cases, the handle 402 may be a telescoping handle. For example, the handle 402 may include a first tubular element 432 and a second tubular element 434. The second tubular element 434 may have an outer diameter that is less than an inner diameter of the first tubular element 432 such that the second tubular element 434 can slide into and out of the lumen of the first tubular element 432. This may allow the length of the handle 402 to be adjusted by adjusting a length of the second tubular element 434 that is exterior to the first tubular element 432, as shown at arrow 438. The handle 402 may further include a rotating locking mechanism 436 configured to releasably secure the second tubular element 434 relative to the first tubular element 432. It is contemplated that the handle 402 may include more than two telescoping portions, if so desired. In yet other embodiments, the handle 402 may have a fixed length. In some embodiments, the battery or power supply 440 may be positioned within a cavity of the handle 402. The handle 402 may include an electrical connection 442 extending between the battery 440 to the distal end 418 thereof to electrically couple the battery 440 to a motor 444 housed within the housing 406 of the grooming tool 404. In other cases, the battery 440 may be provided within or at the housing 406 of the grooming tool 404.

As described above, the handle 402 may be releasably secured to the grooming tool 404. This may allow the handle 402 to be used interchangeably with other grooming tools. It is further contemplated that removable and/or replaceable pads for carrying the cleaning fibers may further allow the groomer to customize the grooming system 400 to desired the grooming task. For example, the groomer may select the desired rotational movement, the desired cleaning fiber, etc. It is further contemplated that the system 400 may be provided with a separate external charger to allow extra or replacement batteries (for use in the handle 402 or grooming tool 404) to be charged while the system 400 is in use.

Those skilled in the art will recognize that the present invention may be manifested in a variety of forms other than the specific embodiments described and contemplated herein. Accordingly, departure in form and detail may be made without departing from the scope and spirit of the present invention as described in the appended claims.

1. A grooming tool, comprising:
a housing having a top edge, a bottom edge, and a sidewall extending between the top edge and the bottom edge, the housing defining a cavity;
a first pad forming a portion of a bottom surface of the housing;
a second pad forming a portion of the bottom surface of the housing;
a plurality of cleaning fibers extending from each of the first and second pads; and
a motor operably coupled to the first pad and the second pad;
wherein the first pad is configured to rotate in a first direction relative to a center of the bottom surface of the housing and the second pad is configured to rotate in a second direction opposite the first direction.

2. The grooming tool of claim 1, wherein the first and second pads are removably coupled relative to the housing.

3. The grooming tool of claim 1, wherein at least some of the plurality of cleaning fibers are configured to rotate independent of the first and/or second pads.

4. The grooming tool of claim 1, wherein the first pad has an annular configuration and the second pad is disposed radially inward of the first pad.

5. The grooming tool of claim 1, wherein the motor is disposed within the cavity of the housing.

6. The grooming tool of claim 1, wherein the motor is disposed exterior to the cavity of the housing.

7. The grooming tool of claim 6, wherein the motor is configured to be clipped to a belt of a user.

8. The grooming tool of claim 6, wherein the motor is operably coupled to the first pad and the second pad via a flexible motor shaft.

9. The grooming tool of claim 1, further comprising a handle releasably secured to the housing.

10. The grooming tool of claim 9, wherein the handle comprises a hinge positioned adjacent to a distal end region thereof, the hinge configured to pivot the distal end region of the handle relative to a proximal end region of the handle.

11. The grooming tool of claim 9, wherein the handle is configured to expand or contract between a plurality of lengths.

12-14. (canceled)

15. The grooming tool of claim 1, further comprising an ultrasonic device disposed within the cavity of the housing.

16. The grooming tool of claim 1, further comprising a sonic device disposed within the cavity of the housing.

17. The grooming tool of claim 1, further comprising a gear assembly disposed within the cavity of the housing, the gear assembly operably coupled to the motor and the first and second pads.

18. The grooming tool of claim 1, further comprising one or more intermediate layers positioned between the plurality of cleaning fibers and the first and second pads.

19. The grooming tool of claim 18, wherein the one or more intermediate layers are formed from a compressible material.

20-22. (canceled)

23. The grooming tool of claim 1, further comprising one or more infrared lights.

24. The grooming tool of claim 1, further comprising an air suction and blower system.

25. A grooming system for grooming an animal, the system comprising:
a grooming tool comprising:
a first housing defining a cavity;
a first rotatable pad and a second rotatable pad each forming a portion of a bottom surface of the first housing, the first and second rotatable pad configured to rotate relative to the first housing;
a plurality of cleaning fibers extending from each of the first and second rotatable pads;
a motor; and
a gear assembly operably coupled to the first and second rotatable pads and the motor;
wherein the first rotatable pad is configured to rotate in a first direction relative to a center of the bottom surface of the first housing and the second rotatable pad is configured to rotate in a second direction opposite the first direction.

26. (canceled)

27. The grooming system of claim 25, wherein the motor is disposed in a second housing separate from the first housing.
